(19) United States
(12) Patent Application Publication
(10) Pub. No.: US 2022/0026344 A1
(43) Pub. Date: Jan. 27, 2022

(54) DETECTION DEVICE

(71) Applicant: KONICA MINOLTA, INC., Tokyo (JP)

(72) Inventors: Kengo FUSHIYA, Toyokawa-shi (JP); Takahiro HARA, Tokyo (JP); Dai SUWAMA, Tokyo (JP); Hiroshi MORIMOTO, Tokyo (JP)

(73) Assignee: KONICA MINOLTA, INC., Tokyo (JP)

(21) Appl. No.: 17/350,301

(22) Filed: Jun. 17, 2021

(51) Int. Cl. G01N 21/01; G01N 21/64; G01N 35/10

(52) U.S. Cl. CPC G01N 21/01; G01N 2021/6439; G01N 35/1002; G01N 21/6428

(57) ABSTRACT

A detection device includes a support base having a rotation surface rotatable in a plane, a detector provided on the rotation surface and displaced with rotation of the rotation surface, a first supply port and a second supply port provided above the rotation surface, and an optical measurer measuring optical characteristics of a first supply material and a second supply material supplied from the first supply port and the second supply port to the detector.

### CROSS-REFERENCE TO RELATED APPLICATION

Japanese patent application No. 2020-124537 filed on Jul. 21, 2020, including description, claims, drawings, and abstract the entire disclosure is incorporated herein by reference in its entirety.

### BACKGROUND

### 1. Technological Field

The present invention relates to a detection device.

### 2. Description of the Related Art

As a method for detecting a substance contained in blood, urine, and the like, a method is known in which a specimen such as blood and urine is mixed with a reagent and then the mixture is analyzed (Refer to Unexamined Japanese Patent Publication No. 1998-19901). A detection device used for detecting such a substance dispenses a specimen from a specimen storage and a reagent from a reagent storage and discharges the dispensed specimen and reagent to a detector by, for example, a dispenser such as a probe, and the like, and mixes the dispensed specimen and reagent.

### SUMMARY

Such a device used for detecting a substance is likely to increase in size. However, in order to enable such a device to be easily used in more various places, miniaturization, space saving, cost reduction, and the like are required. Therefore, the device desirably has a simple configuration.

The present invention has been made in view of the above problems. Therefore, an object of the present invention is to provide a detection device having a simple configuration. The above object of the present invention is achieved by the following.

To achieve at least one of the abovementioned objects, according to an aspect of the present invention, the detection device reflecting one aspect of the present invention comprises a support base that has a rotation surface rotatable in a plane; a detector that is provided on said rotation surface and is displaced with rotation of said rotation surface; a first supply port and a second supply port that are provided above said rotation surface; and an optical measurer that measures optical characteristics of a first supply material and a second supply material supplied from said first supply port and said second supply port to said detector.

The objects, features, and characteristics of this invention other than those set forth above will become apparent from the description given herein below with reference to preferred embodiments illustrated in the accompanying drawings.

### BRIEF DESCRIPTION OF THE DRAWING

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a plan view illustrating a schematic configuration of a side surface of a detection device according to an embodiment;

FIG. 2 is a plan view illustrating a configuration of an upper surface of the detection device illustrated in FIG. 1;

FIG. 3A is a plan view illustrating a configuration of a side surface of a detector illustrated in FIG. 1 and the like, and FIG. 3B is a plan view illustrating a configuration of an upper surface of the detector illustrated in FIG. 3A;

FIG. 4 is an enlarged side view illustrating a specimen supply port illustrated in FIG. 1; and

FIG. 5 is a flowchart illustrating an example of a detection method using the detection device illustrated in FIG. 1 and the like.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, an embodiment of a detection device of the present invention will be described with reference to the accompanying drawings. In the drawings, the same members are denoted by the same reference numerals. In addition, dimensional ratios in the drawings are exaggerated for convenience of description, and may be different from actual ratios.

### Embodiment

<Configuration of Detection Device>

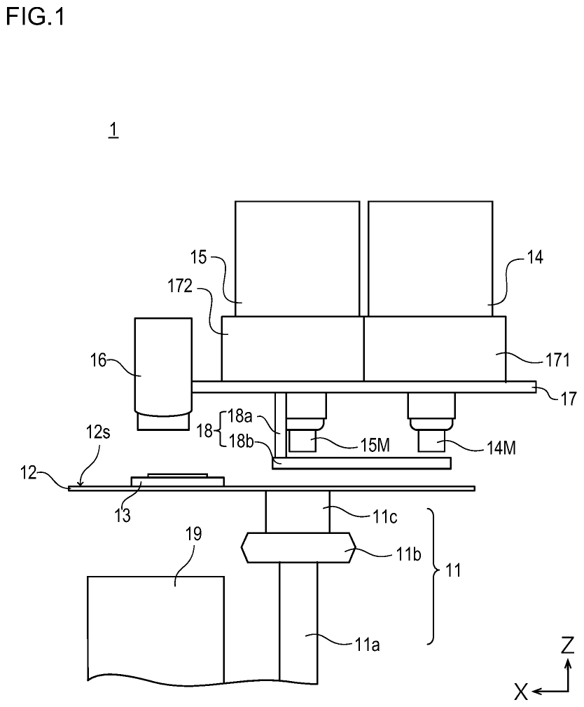

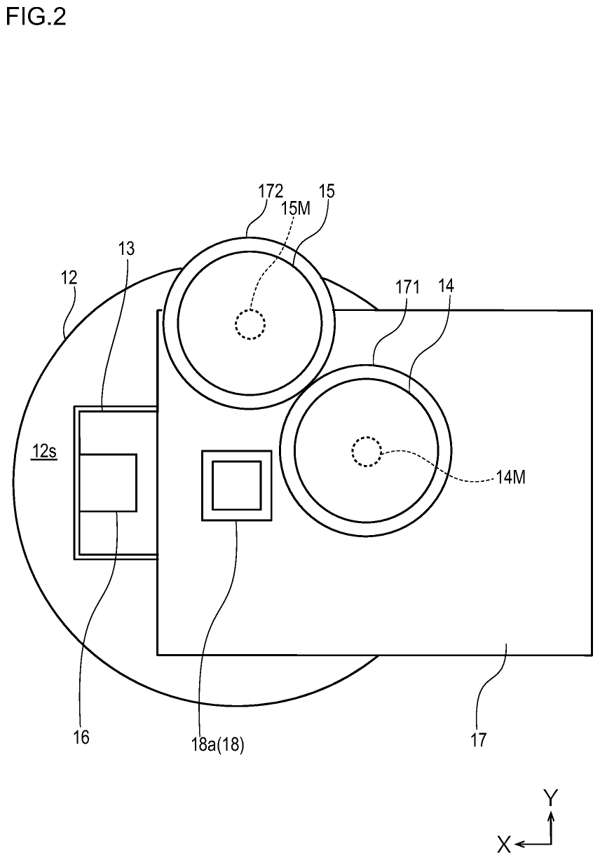

FIGS. 1 and 2 illustrate schematic configurations of a detection device 1 according to an embodiment of the present invention. FIG. 1 illustrates a configuration of a side surface (XZ plane) of the detection device 1, and FIG. 2 illustrates a configuration of an upper surface (XY plane) of the detection device 1. Hereinafter, a vertical direction of the detection device 1 will be described as a Z direction.

The detection device 1 is a device that performs optical measurement of a mixture of a specimen and a reagent. The detection device 1 mainly includes a shaft 11, a support base 12, a detector 13, a specimen supplier 14, a reagent supplier 15, an optical measurer 16, a holding base 17, a supply driver 18, and a waste liquid storage 19. The support base 12 and the detector 13 are provided in this order on the shaft 11. The holding base 17 is disposed above the support base 12, and the reagent supplier 15, the specimen supplier 14, the optical measurer 16, and the supply driver 18 are held on the holding base 17. The waste liquid storage 19 is disposed below the support base 12. Here, the specimen supplier 14 corresponds to a specific example of a first supplier of the present invention, the reagent supplier 15 corresponds to a specific example of a second supplier of the present invention, and the holding base 17 corresponds to a specific example of a holding member of the present invention.

The shaft 11 includes a rotation shaft 11a, a connecting portion 11b, and a rotation shaft 11c in order from a bottom. For example, the rotation shaft 11a is connected to a motor (not illustrated) and axially rotates. The connecting portion 11b connects the rotation shaft 11c coaxially with the rotation shaft 11a. The rotation shaft 11c axially rotates with the rotation of the rotation shaft 11a.

The support base 12 provided on the rotation shaft 11c has a rotation surface 12s (XY plane) substantially perpendicular to the rotation shafts 11a and 11c. The rotation surface 12s has, for example, a circular planar shape (FIG. 2). The support base 12 is a so-called turntable, and the rotation surface 12s rotates clockwise or counterclockwise in the XY plane with the rotation of the rotation shafts 11a and 11c. The detector 13 is provided on the rotation surface 12s, and the detector 13 is displaced with the rotation of the rotation surface 12s. For example, one detector 13 is provided on the rotation surface 12s. A plurality of the detectors 13 may be provided on the rotation surface 12s.

A reagent is supplied from the reagent supplier 15, and a specimen is supplied from the specimen supplier 14 to the detector 13 supported by the support base 12. The detector 13 to which the reagent and the specimen are supplied is irradiated with light from the optical measurer 16.

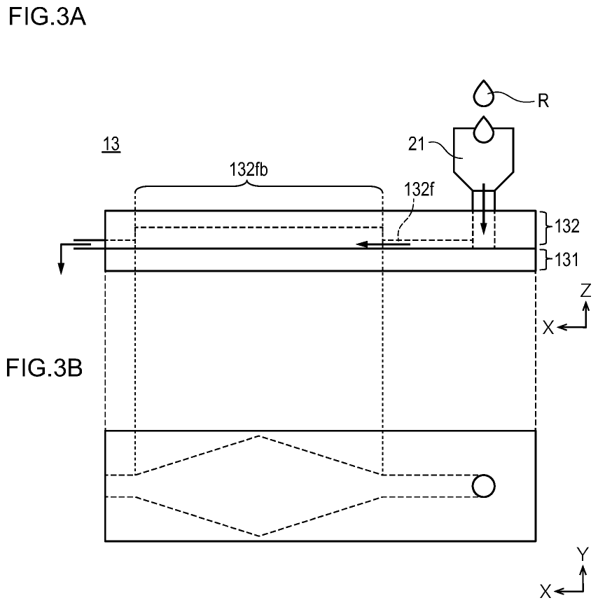

FIGS. 3A and 3B illustrate examples of configurations of the detector 13. FIG. 3A illustrates a configuration of a side surface (XZ plane) of the detector 13, and FIG. 3B illustrates a configuration of an upper surface (XY plane) of the detector 13. For example, the detector 13 has a laminated structure of an opaque member 131 and a transparent member 132 in order from a side of the rotation surface 12s. For example, a receiver 21 is provided on the detector 13.

The opaque member 131 is, for example, a plate-shaped member having a rectangular planar shape. The opaque member 131 is made of a material having low transmittance with respect to light emitted from the optical measurer 16. The opaque member 131 includes, for example, a single crystal silicon (Si) material, a resin material, or the like.

The transparent member 132 is laminated on the opaque member 131, and has, for example, substantially the same planar shape as the opaque member 131. The transparent member 132 is provided with a flow path 132f through which a liquid containing a reagent and a specimen flows. Through the flow path 132f, for example, a liquid containing a reagent and a specimen flows along a long side direction (X direction in FIG. 3) of the transparent member 132. The flow path 132f includes a widened portion 132fb whose width is larger than a width of the flow path 132f in another portion. The widened portion 132fb is provided at a center of the flow path 132f, for example. For example, a specimen and a reagent stored in the widened portion 132fb are irradiated with light from the optical measurer 16 to measure optical characteristics. In the flow path 132f, a surface on a side of the optical measurer 16 may be opened.

The transparent member 132 is made of a material having high transmittance to the light emitted from the optical measurer 16, and the light emitted from the optical measurer 16 reaches the widened portion 132fb. The transparent member 132 includes, for example, a glass material, a resin material, or the like. The glass material included in the transparent member 132 is, for example, silica glass or the like, and high light transmittance can be realized by forming the transparent member 132 using such a glass material. The resin material included in the transparent member 132 is, for example, dimethylpolysiloxane, polystyrene, polycarbonate, cycloolefin, acrylic, or the like. Dimethylpolysiloxane has high transferability to a mold, and can easily form the transparent member 132. By using polystyrene, polycarbonate, cycloolefin, and acrylic, the transparent member 132 can be mass-produced by injection molding. In addition, noise in optical measurement can be reduced by forming the transparent member 132 using polystyrene and cycloolefin having less autofluorescence. By forming the transparent member 132 using polycarbonate having a high refractive index, the detection device 1 can be downsized. By forming the transparent member 132 using acrylic having high light transmittance, attenuation of light at the time of guiding light can be suppressed, and accuracy of optical measurement can be improved. A light incident surface of the transparent member 132 is preferably optically smooth. As a result, the accuracy of measurement by the optical measurer 16 can be improved. Thickness of the transparent member 132 is not particularly limited, and can be adjusted in consideration of rigidity, light transmittance, and the like.

The receiver 21 on the transparent member 132 plays a role of receiving the specimen supplied from the specimen supplier 14 and the reagent supplied from the reagent supplier 15 in an upper portion of the detector 13 and causing the specimen and the reagent to flow into the flow path 132f of the detector 13 (more specifically, the transparent member 132). The receiver 21 has, for example, a funnel shape, and one opening of the receiver 21 is widened away from the transparent member 132. Another opening of the receiver 21 communicates with the flow path 132f. For example, the specimen and the reagent are mixed in the receiver 21 and then flown into the flow path 132f. For example, a vibration mechanism is brought into contact with an outside of the receiver 21 to vibrate the receiver 21, and the specimen and the reagent are mixed in the receiver 21. Alternatively, the specimen and the reagent may be mixed in the flow path 132f. For example, by sucking an inside of the flow path 132f from one end and pumping the flow path 132f, gas and liquid in the flow path 132f move, and the specimen and the reagent are mixed in the flow path 132f.

The specimen supplier 14 held on the holding base 17 stores a predetermined amount of specimen, and the specimen stored in the specimen supplier 14 is supplied to the detector 13. The specimen supplier 14 stores, for example, a specimen diluted with a diluent. The specimen supplier 14 is, for example, a cylindrical container having a height in a Z direction (FIG. 2). The specimen supplier 14 has a specimen supply port 14M at an end on a side of the rotation surface 12s in the Z direction.

The specimen stored in the specimen supplier 14 is, for example, blood, saliva, urine, medicine, environmental water, clean water, sewage, and the like. For example, DNA, RNA, protein, virus, bacteria, contaminants, and the like contained in the specimen are substances to be detected by the detection device 1.

The reagent supplier 15 is held on the holding base 17 together with the specimen supplier 14. The reagent supplier 15 stores a predetermined amount of reagent, and the reagent stored in the reagent supplier 15 is supplied to the detector 13. In the reagent supplier 15, for example, a reagent dispersed or dissolved in a solvent is stored. The reagent supplier 15 has, for example, substantially the same shape as the specimen supplier 14 (FIG. 2). The reagent supplier 15 has a reagent supply port 15M at an end on the side of the rotation surface 12s in the Z direction.

The liquid reagent stored in the reagent supplier 15 is, for example, a dye, a fluorescent substance, a nanoparticle, or the like, and generates physical or chemical binding with a substance to be detected contained in the specimen. As the reagent, a known reagent can be used. The fluorescent substance is, for example, a fluorescent dye, quantum dot, or the like. The nanoparticle is a polystyrene bead, a gold nanoparticle, or the like. For example, by binding such a reagent with the substance to be detected, an optical signal generated at the time of light irradiation is increased, and the substance to be detected is easily detected. In particular, such a reagent is effective when the optical signal of the substance to be detected alone is weak. The reagent may be a substance that causes light absorption or light scattering. At this time, by binding the reagent with the substance to be detected, light intensity generated at the time of light irradiation is reduced, and the optical signal is amplified.

The binding between the reagent and the substance to be detected is, for example, binding by physical adsorption, binding by antigen-antibody reaction, binding by DNA hybridization, biotin-avidin binding, chelate binding, amino binding, or the like. The binding by physical adsorption is, for example, hydrogen binding using electrostatic binding force, or the like. In the binding by physical adsorption, pretreatment or the like of a specimen is unnecessary, and a conjugate of a reagent and a substance to be detected can be easily generated. The binding by the antigen-antibody reaction is, for example, specific binding between a substance to be detected such as a virus and a reagent, and generation of noise derived from impurities other than the substance to be detected contained in the specimen can be suppressed. When a substance to be detected is detected using an antigen-antibody reaction, for example, a reagent with which an antibody is bound is prepared in advance.

The specimen supplier 14 and the reagent supplier 15 are disposed, for example, at adjacent positions in a direction in which the detector 13 is displaced, that is, a rotation direction of the rotation surface 12s. For example, the specimen supplier 14, the reagent supplier 15, and the optical measurer 16 are disposed counterclockwise in this order (FIG. 1). The specimen supplier 14, the reagent supplier 15, and the optical measurer 16 may be disposed in this order in a clockwise direction. The specimen supplier 14, the reagent supplier 15, and the optical measurer 16 may be disposed in an order of the reagent supplier 15, the specimen supplier 14, and the optical measurer 16 counterclockwise or clockwise.

The specimen stored in the specimen supplier 14 is supplied to the detector 13 via the specimen supply port 14M, and the reagent stored in the reagent supplier 15 is supplied to the detector 13 via the reagent supply port 15M. In the present embodiment, the specimen supply port 14M and the reagent supply port 15M are disposed at positions facing the rotation surface 12s, that is, above the rotation surface 12s. Therefore, the detector 13 is displaced immediately below each of the specimen supply port 14M and the reagent supply port 15M by the rotation of the rotation surface 12s. As will be described in detail later, in this way, supply routes of the specimen and the reagent can be simplified. Here, the specimen supply port 14M corresponds to a specific example of a first supply port of the present invention, and the reagent supply port 15M corresponds to a specific example of a second supply port of the present invention.

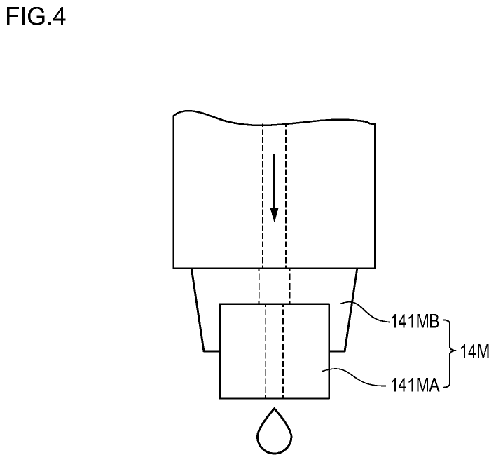

FIG. 4 is an enlarged view near the specimen supply port 14M. The specimen supply port 14M includes, for example, a movable portion 141MA and a passive portion 141MB along the Z direction from the side of the rotation surface 12s. The movable portion 141MA provided on the side of the rotation surface 12s is a portion movable along the Z direction, that is, in the vertical direction. The passive portion 141MB can accommodate a part or all of the movable portion 141MA, and for example, a diameter of the passive portion 141MB is larger than a diameter of the movable portion 141MA.

For example, when the supply driver 18 does not act on the movable portion 141MA, a part or all of the movable portion 141MA protrudes from the passive portion 141MB, and the specimen supply port 14M is closed. When the supply driver 18 acts on the movable portion 141MA, the movable portion 141MA is pushed upward by the supply driver 18, and a part or all of the movable portion 141MA is accommodated in the passive portion 141MB. As a result, the specimen supply port 14M is opened, and the specimen is discharged downward from the specimen supply port 14M.

The reagent supply port 15M has, for example, the same configuration as the specimen supply port 14M (see FIG. 4).

The optical measurer 16 is held on the holding base 17 together with the specimen supplier 14 and the reagent supplier 15, for example, and measures optical characteristics of the specimen and the reagent supplied to the detector 13. The optical measurer 16 is disposed above the rotation surface 12s, and the detector 13 can be disposed at a position facing the optical measurer 16, that is, immediately below the optical measurer 16. From a measurement result of the optical measurer 16, presence or content of the substance to be detected contained in the specimen is detected.

For example, the optical measurer 16 irradiates the detector 13 with light and detects an optical signal generated by the detector 13. The optical measurer 16 includes, for example, an irradiator and a light receiver. The irradiator and the light receiver are disposed at positions facing the rotation surface 12s, for example.

The irradiator includes a light source, and emits light from the light source toward the detector 13. The light emitted from the irradiator to the detector 13 is, for example, light in a wavelength band capable of exciting the fluorescent substance. The light source is, for example, a lamp, an LED (Light Emitting Diode), a laser, or the like. The light generated by the light source may be monochromatic light or light having a wide wavelength band. When the light generated by the light source has a wide wavelength band, the irradiator preferably includes an optical filter such as a band pass filter. When a lamp, an LED, or the like is used as a light source, the irradiator preferably includes a guide member that regulates a traveling direction of light generated by the light source. The guide member is, for example, a collimating lens, or the like.

The light receiver includes, for example, an imaging device such as a photodiode, a photodetector, a CCD (Charge Coupled Device) image sensor, a CMOS (Complementary Metal Oxide Semiconductor) image sensor, or the like. The photodetector is, for example, a photomultiplier tube or the like. A known imaging device can be used as the light receiver. The light receiver detects the light intensity or spectrum of the light incident on the optical measurer 16. The light receiver may detect the intensity of light having a single wavelength or may detect the intensities of light having a plurality of wavelengths. When the light emitted from the irradiator is incident on the detector 13, for example, a conjugate of the reagent and the substance to be detected is excited by this light, and an optical signal is generated. The generated optical signal is reflected directly or on an interface between the transparent member 132 and the opaque member 131 to be incident on the light receiver.

The holding base 17 that holds the specimen supplier 14, the reagent supplier 15, and the optical measurer 16 is disposed above the support base 12, and a part of the holding base 17 faces the support base 12. A specimen holder 171 and a reagent holder 172 are provided on an upper surface of the holding base 17.

The specimen holder 171 and the reagent holder 172 are fixed to the upper surface of the holding base 17. The specimen holder 171 and the reagent holder 172 each have, for example, a ring shape, and the specimen supplier 14 is held inside the specimen holder 171, and the reagent supplier 15 is held inside the reagent holder 172. The specimen supplier 14 and the reagent supplier 15 are configured to be detachable from the specimen holder 171 and the reagent holder 172, respectively.

The supply driver 18 that acts on the specimen supply port 14M and the reagent supply port 15M is fixed to, for example, the holding base 17. The supply driver 18 includes, for example, an actuator 18a and a plate-shaped member 18b connected to the actuator 18a.

The actuator 18a moves along a direction substantially perpendicular to the rotation surface 12s (Z direction), and plays a role of causing the plate-shaped member 18b to move in the vertical direction. The plate-shaped member 18b connected to the actuator 18a moves in the vertical direction along with the movement of the actuator 18a. A main surface of the plate-shaped member 18b has, for example, a rectangular shape, and is provided substantially parallel to the rotation surface 12s. One end of the plate-shaped member 18b is connected to the actuator 18a above and near the center of the rotation surface 12s, and another end of the plate-shaped member 18b is provided above and near an outer periphery of the rotation surface 12s.

In the supply driver 18, for example, the vicinity of the other end of the plate-shaped member 18b moved in an upward direction comes into contact with the specimen supply port 14M or the reagent supply port 15M. As a result, the specimen supply port 14M or the reagent supply port 15M is opened. For example, the other end of the plate-shaped member 18b is displaced in the rotation direction of the rotation surface 12s, and can be selectively brought into contact with one of the specimen supply port 14M and the reagent supply port 15M. As a result, the supply driver 18 can be shared by the specimen supply port 14M and the reagent supply port 15M, and the configuration of the detection device 1 can be further simplified. The other end of the plate-shaped member 18b is displaced, for example, with the rotation of the rotation surface 12s.

The waste liquid storage 19 disposed below the support base 12 stores, for example, waste liquid generated when the detector 13 is cleaned. For example, after the optical characteristics of the mixture of the specimen and the reagent supplied to the detector 13 are measured, a cleaning liquid is supplied to the detector 13. The cleaning liquid is supplied to the detector 13 via the receiver 21, for example. Together with the cleaning liquid supplied to the detector 13, the specimen and the reagent in the flow path 132f are discharged to the waste liquid storage 19. The waste liquid is discharged to the waste liquid storage 19, for example, by sucking one end of the flow path 132f. In this manner, by cleaning the detector 13 after measuring the optical characteristics, the detector 13 can be reused. A cleaning liquid supplier (not illustrated) storing a cleaning liquid may be disposed below the support base 12.

<Detection Method Using Detection Device>

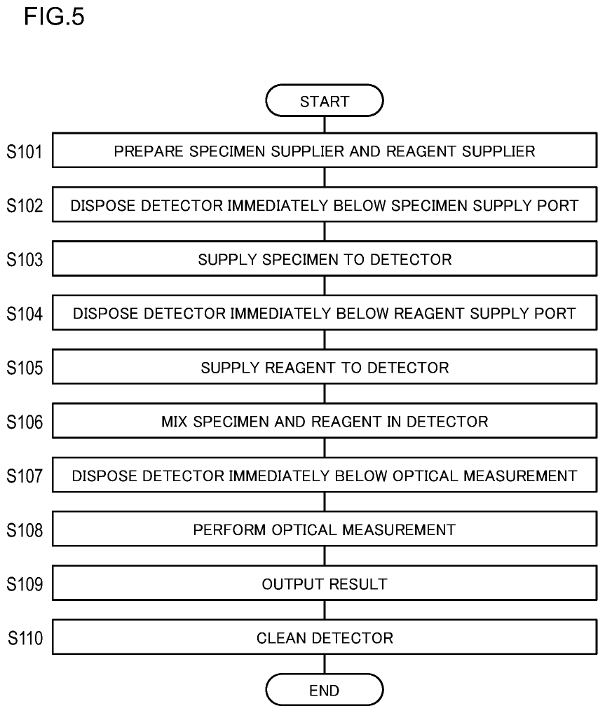

Hereinafter, a detection method using the detection device 1 of the present embodiment will be described with reference to FIG. 5. FIG. 5 is a flowchart illustrating the detection method of the present embodiment.

First, the specimen supplier 14 and the reagent supplier 15 are prepared (step S101). Specifically, the specimen supplier 14 storing the specimen is held by the specimen holder 171, and the reagent supplier 15 storing the reagent is held by the reagent holder 172.

Next, the detector 13 placed on the rotation surface 12s is disposed immediately below the specimen supply port 14M (step S102). Next, the specimen is supplied from the specimen supplier 14 to the detector 13 via the specimen supply port 14M (step S103). Specifically, the other end of the plate-shaped member 18b of the supply driver 18 is brought into contact with the specimen supply port 14M to open the specimen supply port 14M. As a result, the specimen is discharged from the specimen supply port 14M, and the specimen drops from the specimen supply port 14M to the detector 13.

After a predetermined amount of specimen is supplied to the detector 13, the detector 13 is disposed immediately below the reagent supply port 15M (step S104). Specifically, the rotation surface 12s is rotated counterclockwise, and the detector 13 is displaced immediately below the reagent supply port 15M.

Subsequently, the reagent is supplied from the reagent supplier 15 to the detector 13 via the reagent supply port 15M (step S105). Specifically, the other end of the plate-shaped member 18b of the supply driver 18 is brought into contact with the reagent supply port 15M to open the reagent supply port 15M. As a result, the reagent is discharged from the reagent supply port 15M, and the reagent drops from the reagent supply port 15M to the detector 13.

After a predetermined amount of reagent is supplied to the detector 13, the specimen and the reagent supplied to the detector 13 are mixed (step S106). For example, the specimen and the reagent are mixed by reciprocating liquid delivery in the flow path 132f. As a result, a conjugate of the reagent and the substance to be detected contained in the specimen is generated.

Next, the detector 13 is disposed immediately below the optical measurer 16 (step S107). Specifically, for example, the rotation surface 12s is rotated counterclockwise, and the detector 13 is displaced immediately below the optical measurer 16 (step S107).

Subsequently, optical measurement of the mixed specimen and reagent is performed (step S108). Specifically, the optical measurer 16 emits light toward the detector 13 and receives light incident on the optical measurer 16 from a side of the detector 13. After the optical measurement of the detector 13 is performed, a result of the optical measurement is output (step S109). The result of the optical measurement is determined by, for example, image processing and output.

Thereafter, the detector 13 is cleaned (step S110). Cleaning of the detector 13 is performed, for example, as follows. First, the rotation surface 12s is rotated so that the detector 13 is displaced immediately above the cleaning liquid supplier, and the cleaning liquid is supplied from the cleaning liquid supplier to the detector 13. Next, the specimen and the reagent in the flow path 132f are discharged to the waste liquid storage 19 together with the supplied cleaning liquid. The discharge to the waste liquid storage 19 may be performed after the detector 13 is displaced immediately above the waste liquid storage 19. Subsequently, the rotation surface 12s is rotated to displace the detector 13 immediately below the optical measurer 16, and optical measurement of the detector 13 is performed. Thereafter, the result of the optical measurement is output, and when it is confirmed that the detector 13 has been cleaned, the cleaning ends. When the cleaning of the detector 13 is insufficient, the supply and discharge of the cleaning liquid to the detector 13 are repeated again.

After the detector 13 is cleaned, the detection ends. Alternatively, after the detector 13 is cleaned, the process may return to step S101.

<Functions and Effects of Detection Device>

In the detection device 1 of the present embodiment, the support base 12 has the rotation surface 12s, and the specimen supply port 14M and the reagent supply port 15M are provided above the rotation surface 12s, so that the detector 13 is displaced immediately below each of the specimen supply port 14M and the reagent supply port 15M by the rotation of the rotation surface 12s. As a result, the supply routes of the specimen and the reagent to the detector 13 can be simplified. Hereinafter, functions and effects of the detection device 1 will be described.

For example, a detection device that supplies a specimen and a reagent to a sensor without displacing the sensor can be considered. In such a detection device, a specimen supply port and a reagent supply port are not provided above the sensor, and the specimen and the reagent are supplied to the sensor as follows. First, after a predetermined amount of specimen is sucked from a specimen storage by a dispenser such as a probe, the dispenser is moved above the sensor, and the specimen is discharged from the dispenser to the sensor. Next, after a predetermined amount of reagent is sucked from a reagent storage by the dispenser, the reagent is moved above the sensor, and the reagent is discharged from the dispenser to the sensor

In such a detection device, it is necessary to move the specimen or the reagent sucked by the dispenser above the sensor, and the supply routes of the specimen and the reagent tends to be complicated. In addition, in such a supply route, a conveyance system for moving the dispenser that has sucked the specimen or the reagent above the sensor is required, and the number of parts increases. Therefore, such a detection device may cause an increase in size and cost.

On the other hand, in the detection device 1, the support base 12 has the rotation surface 12s, and the specimen supply port 14M and the reagent supply port 15M are provided above the rotation surface 12s. Therefore, by placing the detector 13 on the rotation surface 12s and rotating the rotation surface 12s, the detector 13 is displaced immediately below each of the specimen supply port 14M and the reagent supply port 15M. Therefore, the specimen and the reagent can be directly supplied from each of the specimen supply port 14M and the reagent supply port 15M to the detector 13. That is, the supply routes of the specimen and the reagent to the detector 13 can be simplified.

Further, in the detection device 1, since the specimen and the reagent are directly supplied from each of the specimen supply port 14M and the reagent supply port 15M to the detector 13, a conveyance system for moving the specimen and the reagent is unnecessary, and an increase in the number of parts can be suppressed. Therefore, it is possible to reduce the size and cost of the detection device 1.

Furthermore, in the detection device 1, the specimen and the reagent can be supplied to the detector 13 without suction and discharge of the specimen and the reagent by a dispenser such as a probe. Therefore, in the detection device 1, a pipetting system for a dispenser is unnecessary, and an increase in the number of parts can be further suppressed. Therefore, it is possible to more effectively reduce the size of the detection device 1 and to suppress the cost.

In addition, in the detection device 1, since the optical measurer 16 is provided above the rotation surface 12s, the detector 13 can be displaced immediately below the optical measurer 16. Thus, the optical measurement of the detector 13 can be easily performed.

As described above, in the detection device 1 of the present embodiment, since the support base 12 has the rotation surface 12s, and the specimen supply port 14M and the reagent supply port 15M are provided above the rotation surface 12s, the detector 13 is displaced immediately below each of the specimen supply port 14M and the reagent supply port 15M by the rotation of the rotation surface 12s. As a result, the supply routes of the specimen and the reagent can be simplified. Therefore, the configuration of the detection device 1 can be simplified.

As described above, the detection device of the present invention has been described in the embodiment. However, it goes without saying that the present invention can be appropriately added, modified, and omitted by those skilled in the art within the scope of the technical idea.

For example, in the above embodiment, an example has been described in which the detector 13 after the optical measurement is performed is cleaned and the detector 13 is reused, but the detector may be replaced with a new detector 13 every time the optical measurement is performed. At this time, the detection device may not be provided with the waste liquid storage.

Further, in the above embodiment, an example has been described in which both the irradiator and the light receiver of the optical measurer 16 are provided above the rotation surface 12s, but the irradiator and the light receiver of the optical measurer 16 may be provided at other positions. For example, the irradiator may be provided above the rotation surface 12s, and the light receiver may be provided below the rotation surface 12s.

Further, in the above embodiment, an example has been described in which the specimen supplier 14 has the specimen supply port 14M and the reagent supplier 15 has the reagent supply port 15M, but the specimen supplier 14 and the specimen supply port 14M may be provided separately, and the reagent supplier 15 and the reagent supply port 15M may be provided separately. Further, the specimen supply port 14M and the reagent supply port 15M may be provided in a dispenser such as a probe.

Further, in the above embodiment, an example has been described in which one specimen supply port 14M and one reagent supply port 15M are held by the holding base 17, but a plurality of the specimen supply ports 14M or a plurality of the reagent supply ports 15M may be held by the holding base 17. That is, the detection device of the present invention may include a third supply port, a fourth supply port, and the like. At this time, a third supply material is supplied from the third supply port to the detector, and a fourth supply material is supplied from the fourth supply port to the detector.

Further, the detection method described above may include steps other than the steps in the flowchart described above, or may not include some of the steps described above. Further, the order of the steps is not limited to the above embodiment.

Although embodiments of the present invention have been described and illustrated in detail, the disclosed embodiments are made for purpose of illustration and example only and not limitation. The scope of the present invention should be interpreted by terms of the appended claims.

1. A detection device comprising:
a support base that has a rotation surface rotatable in a plane;
a detector that is provided on said rotation surface and is displaced with rotation of said rotation surface;
a first supply port and a second supply port that are provided above said rotation surface; and
an optical measurer that measures optical characteristics of a first supply material and a second supply material supplied from said first supply port and said second supply port to said detector.

2. The detection device according to claim 1, further comprising a holding member that holds said first supply port and said second supply port.

3. The detection device according to claim 2, further comprising:
a first supplier that has said first supply port and stores said first supply material; and
a second supplier that has said second supply port and stores said second supply material.

4. The detection device according to claim 3, wherein said first supplier and said second supplier are configured to be detachable from said holding member.

5. The detection device according to claim 1, wherein said detector is displaced to a position facing each of said first supply port, said second supply port, and said optical measurer by rotation of said rotation surface.

6. The detection device according to claim 1, wherein said first supply port and said second supply port are disposed at positions adjacent to each other in a direction in which said detector is displaced.

7. The detection device according to claim 1, wherein said optical measurer is provided above said rotation surface.

8. The detection device according to claim 1, further comprising a supply driver that causes each of said first supply port and said second supply port to open.

9. The detection device according to claim 1, wherein said first supply material includes a specimen and said second supply material includes a reagent.

10. The detection device according to claim 1, further comprising waste liquid storage that receives waste liquid discharged from said detector.

11. The detection device according to claim 10, wherein said waste liquid storage is provided below said rotation surface.

12. The detection device according to claim 1, wherein said first supply material and said second supply material are liquids.

13. The detection device according to claim 12, wherein said detector is provided with a flow path of said first supply material and said second supply material.

14. The detection device according to claim 13, wherein said flow path has a widened portion whose width is larger than a width of another portion of said flow path.
